(19) United States
(12) Patent Application Publication
(10) Pub. No.: US 2016/0123687 A1
(43) Pub. Date: May 5, 2016

(54) COLOR-CHANGING FIREARM COMPONENTS

(71) Applicant: Lancer Systems L.P., Quakertown, PA (US)

(72) Inventors: Robert D. Cook, JR., Collegeville, PA (US); Kasimere McManus, Quakertown, PA (US)

(21) Appl. No.: 14/932,406

(22) Filed: Nov. 4, 2015

Related U.S. Application Data
(60) Provisional application No. 62/074,884, filed on Nov. 4, 2014.

(51) Int. Cl. F41A 9/70; B05D 1/02

(52) U.S. Cl. CPC F41A 9/70; B05D 1/02

(57) ABSTRACT

The present application teaches a color-changing component for a firearm and methods for constructing same. In some embodiments the component is a magazine comprising a photochromatic body that changes color and/or opacity based on the introduction or removal of light to the body. In alternate embodiments the component is any type of weapon-mounted aiming or sight-aiding device for which it would be desirable to reduce the risk of reflective glare or glint.

### FIELD OF THE INVENTION

The present invention relates to ammunition magazines and other components for firearms, more particularly to firearm components that are capable of changing color and/or opacity based on the introduction of energy, for example light, heat, or electricity.

### BACKGROUND OF THE INVENTION

Firearms magazines generally extend outwardly from the body of a firearm, and therefore are generally visible when the firearm is in use. In order to provide adequate camouflage for the firearm for different environments, magazines are presently offered in different colors and prints. If a firearm user must move from one environment to another, they currently must change their magazine in order to maximize the effectiveness of the camouflage. This represents both a cost and operational burden for the firearm user. During bright-light environments, clear-bodied magazines have the further disadvantage of exposing the metal cartridges contained within the magazine to reflected light, which can present an operational disadvantage by giving away a user's position.

Optics components, such as scope lenses and covers therefor, are sometimes subjected to reflected light that could cause noticeable glint in certain settings. This can likewise present an operational disadvantage by giving away a user's position.

Accordingly, there is a need for firearm components that address these problems and overcome the limitations of the prior art devices.

### SUMMARY OF THE INVENTION

In one respect, the present application discloses a magazine for a firearm, the magazine comprising a body having a feed end, a bottom end, and a wall that extends between the feed end and bottom end; a follower; and a follower spring; wherein at least a portion of the body is comprised of a color-changing material.

In another respect, the present application discloses a method of constructing a photochromatic component for a firearm, the component having a body, the method comprising: mixing together a photochromatic filler and a carrier to form a photochromatic slurry; and applying the photochromatic slurry to at least a portion of the body.

In yet another respect, the present application discloses a method of constructing a photochromatic magazine for a firearm, the magazine having a body, a follower, and a follower spring, the method comprising: mixing together a photochromatic filler, a carrier, and a polymer material to form a mixture; and forming the mixture into at least a portion of the body.

### BRIEF DESCRIPTION OF THE DRAWINGS

The foregoing summary, as well as the following detailed description of the invention, will be better understood when read in conjunction with the appended drawings. For the purpose of illustrating the invention disclosed herein, certain embodiments in accordance with the herein disclosed invention are shown in the drawings. It should be understood, however, that the herein disclosed invention is not limited to the precise arrangements shown. It should also be understood that, in the drawings, the parts are not necessarily drawn to scale. The present invention will hereinafter be described in conjunction with the appended drawing figures, wherein like numerals denote like elements. In the drawings:

FIG. 1 is a photographic side view of a magazine according to the present invention in an indoor environment;

FIG. 2 is a photographic side view of the magazine of FIG. 1 after the magazine has been exposed to natural lighting in an outdoor environment; and

FIG. 3 is a flow chart illustrating an exemplary method of constructing a firearm component according to the present invention.

### DETAILED DESCRIPTION OF THE PREFERRED EMBODIMENTS

The ensuing detailed description provides preferred exemplary embodiments only, and is not intended to limit the scope, applicability, or configuration of the herein disclosed inventions. Rather, the ensuing detailed description of the preferred exemplary embodiments will provide those skilled in the art with an enabling description for implementing the preferred exemplary embodiments in accordance with the herein disclosed invention. It should be understood that various changes may be made in the function and arrangement of elements without departing from the spirit and scope of the invention, as set forth in the appended claims.

To aid in describing the invention, directional terms may be used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

For purposes of this specification and the appended claims, the term “color-changing material” has the meaning of a material having a different color, transparency, and/or opacity when exposed to a specific form of energy then when not exposed to that form of energy, and includes but is not limited to the terms “photochromatic,” “thermochromatic,” and “electrochromatic” as defined herein below.

For purposes of this specification and the appended claims, the term “photochromatic” has the meaning of a material that changes color, transparency, and/or opacity when exposed to light, most commonly a light in the ultraviolet portion of the spectrum.

For purposes of this specification and the appended claims, the term “thermochromatic” has the meaning of a material that changes color, transparency, and/or opacity when exposed to a change in temperature. The term “thermochromatic” is interchangeable with the term “thermochromic.”

For purposes of this specification and the appended claims, the term “electrochromatic” has the meaning of a material that changes color, transparency, and/or opacity when exposed to an electrical current. The term “electrochromatic” is interchangeable with the term “electrochromic.”

For purposes of this specification and the appended claims, the term “ultraviolet light” or “UV light” means light in the band of 280-400 nanometers.

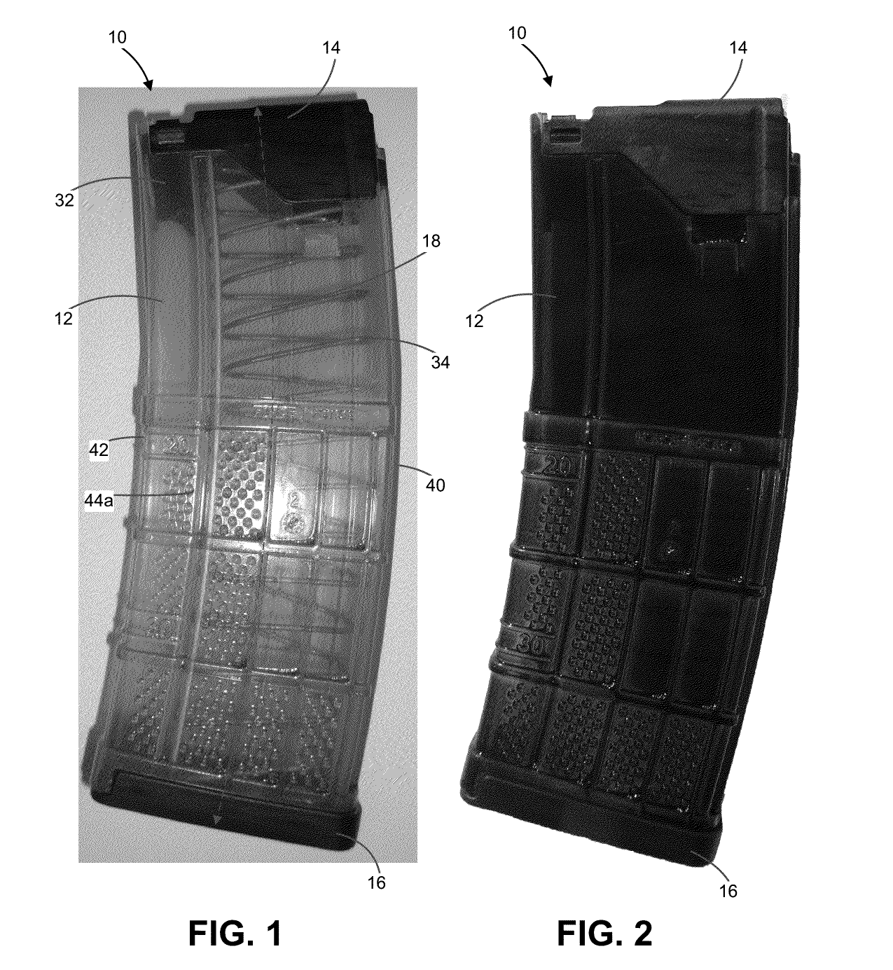

Referring now to the Figures, FIG. 1 shows an exemplary photochromatic firearm magazine 10 in accordance with a first embodiment of the present invention. The magazine 10 has a body 12, a top (feed) end 14, a bottom end 16, and a height 18 that is measured along the body 12 between the feed end 14 and the bottom end 16. The body 12 comprises a front wall 40, a rear wall 42, and a pair of sidewalls (only sidewall 44a is labeled in FIG. 1). The magazine 10 further comprises a follower 32 and a follower spring 34, as would be understood by a person having ordinary skill in the art. In this embodiment, the body 12 comprises a color-changing material, more specifically, a photochromatic material. FIG. 1 shows the magazine 10 in an environment where it is being exposed to little or no ultraviolet (UV) light (e.g., preferably no more than 1 mW/cm̂2). As can be seen in FIG. 1, in this environment the body 12 of the magazine 10 is relatively clear and translucent and has relatively low opacity. In this state, the transmittance of a single wall (e.g., any of walls 40,42,44a) of the body 12 is preferably at least 90 percent and, more preferably, at least 95 percent.

FIG. 2 shows the magazine 10 of FIG. 1 after the magazine 10 has been exposed to direct natural light (UV light intensity of at least 10 milliwatts per square centimeter (10 mW/cm̂2)) in an outdoor environment for approximately two minutes. As can be seen in FIG. 2, due to the body 12 of the magazine 10 having been exposed to UV-containing natural light, the body 12 of the magazine 10 has now significantly darkened, become far less translucent, and increased greatly in opacity. In this state, the transmittance of a single wall (e.g., any of walls 40,42,44a) of the body 12 is no more than 60 percent, and preferably no more than 50 percent.

The change in haze, transparency, and/or total transmittance of the body 12 of the magazine 10 can be measured using known transparency and haze meters produced by BYK-Gardner GmbH of Geretsried, Germany while applying known testing standards, for example ASTM D1746-15, entitled “Standard Test Method for Transparency of Plastic Sheeting,” which is incorporated herein by reference as if set forth in its entirety. A copy of this Standard is available online at http://www.astm.org/Standards/D1746.htm as of the date of filing of this application. In various embodiments according to the present invention, the transparency of the body 12 of the magazine 10 can change by between 1-10%, between 10-25%, between 25-50%, or greater than 50%.

In the embodiment shown in FIGS. 1 and 2, the body 12 of the magazine 10 is comprised of nylon. In alternate embodiments according to the present invention, the body of the magazine may be comprised of other suitable materials, for example polyphenylsulfone (PPSU), polycarbonate (PC), acrylic, polymethyl methacrylate (PMMA), polyethylene terephthalate (PE), polyether ether ketone (PEEK), or styrene, and including virgin, co-polymer, and/or fiber-reinforced embodiments of one or more of these materials.

In some embodiments according to the present invention, the body of the magazine will meet the relevant specifications for luminous transmittance, neutrality, chromaticity, and haze as set forth in paragraphs 3.5.2.8-3.5.2.14 of Military Performance Specification No. MIL-PRF-31013, published 25 Apr. 1996, entitled “Spectacles, Special Protective Eyewear Cylindrical System (SPECS)”, which is incorporated herein by reference as if set forth in its entirety. A copy of this Specification is available online at: http://everyspec.com/MIL-PRF/MIL-PRF-030000-79999/MIL-PRF-31013 20540/ as of the date of filing of the present application.

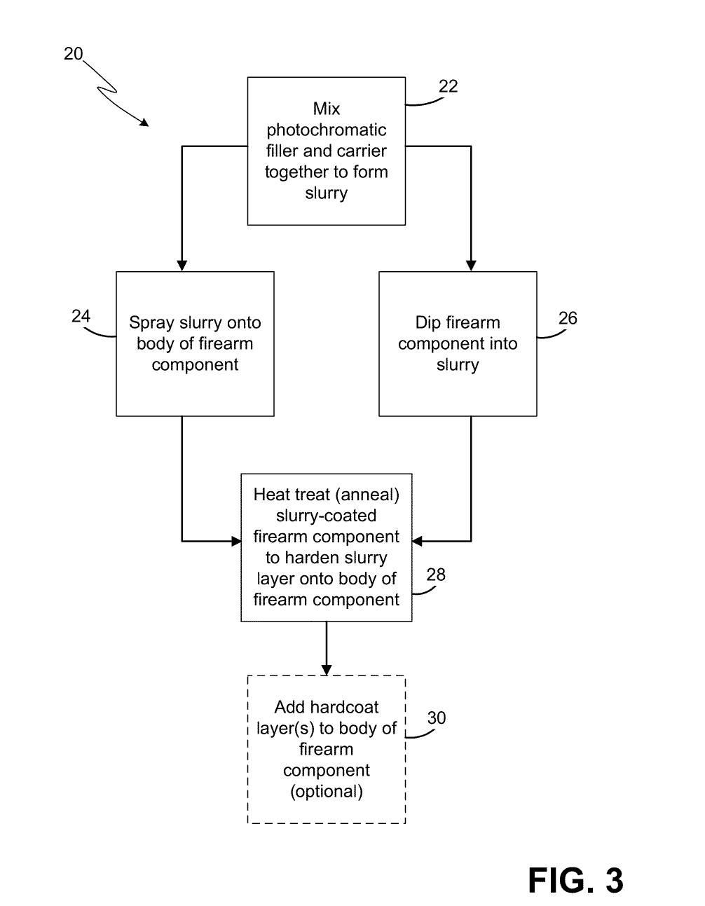

FIG. 3 illustrates an exemplary method 20 of constructing a firearm component, for example the magazine 10 of FIGS. 1 and 2, according to the present invention. In this method 20, a photochromatic filler and a carrier are mixed together at step 22 to form a slurry. The photochromatic filler preferably comprises between 0.1%-10%, more preferably between 1%-5%, and most preferably between 2-4% by volume of the slurry. Then, the slurry is either sprayed onto the body 12 of the magazine 10 at step 24, or the body 12 of the magazine 10 is dipped into the slurry at step 26 so that the body 12 becomes coated with the slurry. The body 12 of the magazine 10, which is now coated with a slurry layer, is then heat-treated and slowly cooled (i.e., annealed) at step 28 in order to harden the slurry layer onto the body 12. Optionally, one or more hardcoat layer(s) are finally added to the body 12 of the magazine 10 at step 30 to provide additional protection to the slurry layer and magazine 10. It should be understood that the process described in this paragraph is applicable to any type of firearm component, and is not limited to firearm magazines.

There are many types of photochromatic material known in the art, such as spiroxazines and spiropyrans. In the embodiment shown in FIGS. 1 and 2, the photochromatic filler used is a proprietary formulation sourced from Vivimed Labs USA, Inc. of Monmouth Junction, N.J., U.S.A., although other photochromatic fillers may be used in alternate embodiments according to the present invention. In the embodiment shown in FIGS. 1 and 2, the carrier is an epoxy resin lacquer, although other carriers would be suitable in alternate embodiments according to the present invention.

If one or more hardcoat layer(s) are applied to the magazine 10 at optional step 30, silicone may be used as the hardcoat. The hardcoat layer(s) add scratch and abrasion resistance to the body 12 of the magazine 10, and can also be used to modify the exterior appearance of the body 12 of the magazine 10, for example by increasing or decreasing the reflectivity of the body 12 or altering the texture of the exterior surface of the body 12.

In an alternate method for constructing a photochromatic magazine, the photochromatic slurry may be mixed directly into the substrate material that forms the body of the magazine prior to the body of the magazine being formed. In this method, the annealing and hardcoating steps may optionally be omitted.

In the embodiment of the magazine 10 shown in FIGS. 1 and 2, the color-changing characteristics of the body 12 of the magazine 10 are owed to exposure with UV light, i.e., the body 12 is photochromatic. It should be understood that in alternate embodiments of the present invention a color-change of the body of the magazine can be affected through the introduction of heat and/or an electrical current. For example, the magazine body could be coated, sprayed, or formed with a thermochromatic paint or dye that changes color due to a change in temperature in the surrounding environment. For example, the thermochromatic dye could present a white or clear color at low temperatures (e.g., below 32 degrees Fahrenheit, perhaps best befitting a cold or snowy environment), and present a much darker color at higher temperatures (e.g., above 80 degrees Fahrenheit).

In further alternate embodiments, the magazine body could be coated, sprayed, or formed with an electrochromatic paint or dye that changes color due to the introduction of an electrical current. Because many modern firearms are designed to support power source(s) for operating lights, scopes, and other accessories, said power source(s) can be used to selectively introduce an electrical charge to the body of the magazine, thereby altering its color based on the environment in which the firearm is being used. For example, in an unpowered state the magazine may be a clear or light color and in a powered state may become a darker color, or vice-versa. Because power sources can fail during operations, an important consideration in selecting what the default (i.e., unpowered) color of the magazine should be is which color state is more generally acceptable in a particular environment. For example, while a dark-colored magazine body may be preferable to a light-colored or clear magazine body during nighttime use, in general it may be preferable to have the default (i.e., unpowered) color of the magazine body be light-colored or clear, because a light-colored or clear magazine at night is generally preferable to a dark-colored magazine during the day.

In further alternate embodiments, only a portion of the body of the magazine (e.g., one or more vertical windows aligned with all or a portion of the height of the magazine in which the cartridges are located) may be provided with color-changing properties, and the remainder of the magazine may be provided in a solid (e.g., opaque) color. In that way, the window can provide a transparent view into the magazine in low-light or nighttime environments, but will become sufficiently opaque during daytime environments such that no reflection of light occurs off of the metal cartridges located inside the cartridge.

In further alternate embodiments, the materials and methods disclosed herein could be used to construct all or portion(s) of any firearm component for which it would be desirable to reduce the risk of reflective glare or glint. A non-exhaustive list of additional firearm components that could be all or partially constructed using the materials and methods taught herein includes: scope lenses and covers for scope lenses; sunshades for all optic types; non-magnified optic lenses and covers (such as various holographic, red dot, and laser weapon sights); and any other weapon-mounted aiming or sight-aiding device for which it would be desirable to reduce the risk of reflective glare or glint.

It should be appreciated that the foregoing is presented by way of illustration only, and not by way of any limitation, and that various alternatives and modifications may be made to the illustrated embodiments without departing from the spirit and scope of the present invention.

1. A magazine for a firearm, the magazine comprising:
a body having a feed end, a bottom end, and a wall that extends between the feed end and the bottom end;
a follower; and
a follower spring;
wherein at least a portion of the body is comprised of a color-changing material.

2. The magazine of claim 1, wherein at least a portion of the body is a first color when it is exposed to at least 10 mW/cm̂2 of UV light and a second color when it is exposed to less than 1 mW/cm̂2 of UV light.

3. The magazine of claim 2, wherein the at least a portion of the body changes opacity when it is exposed to light.

4. The magazine of claim 1, wherein at least a portion of the body changes opacity when it is exposed to light.

5. The magazine of claim 4, the wall comprising the at least a portion of the body that is comprised of the color-changing material, wherein the wall has at least 90 percent transmittance when it is exposed to less than or equal to 1 mW/cm̂2 of UV light.

6. The magazine of claim 5, wherein the wall has no more than 60 percent transmittance when it is exposed to greater than or equal to 10 mW/cm̂2 of UV light.

7. The magazine of claim 4, the wall comprising the at least a portion of the body that is comprised of the color-changing material, wherein the wall has no more than 60 percent transmittance when it is exposed to greater than or equal to 10 mW/cm̂2 of UV light.

8. The magazine of claim 1, wherein at least a portion of the body changes color when it is exposed to a change in temperature.

9. The magazine of claim 8, wherein at least a portion of the body changes opacity when it is exposed to a change in temperature.

10. The magazine of claim 1, wherein at least a portion of the body changes opacity when it is exposed to a change in temperature.

11. The magazine of claim 1, wherein at least a portion of the body changes color based on the introduction of an electrical current to the at least a portion of the body or removal of an electrical current from the at least a portion of the body.

12. The magazine of claim 11, wherein the at least a portion of the body changes opacity based on the introduction of an electrical current to the at least a portion of the body or removal of an electrical current from the at least a portion of the body.

13. The magazine of claim 1, wherein the body changes opacity based on the introduction of an electrical current to the body or removal of an electrical current from the body.

14. The magazine of claim 1, wherein the entirety of the body comprises the color-changing material.

15. The magazine of claim 1, wherein a first portion of the body comprises the color-changing material and a second portion of the body does not comprise the color-changing material.

16. The magazine of claim 15, wherein the first portion of the body comprises at least one window oriented along at least a portion of a height of the body, the height being measured along the body between the feed end and the bottom end.

17. A method of constructing a photochromatic component for a firearm, the component having a body, the method comprising:
mixing together a photochromatic filler and a carrier to form a photochromatic slurry; and
applying the photochromatic slurry to at least a portion of the body.

18. The method of claim 17, wherein the step of applying the photochromatic slurry to the body further comprises spraying the photochromatic slurry onto the body, the method further comprising annealing the body after the applying step.

19. The method of claim 17, wherein the step of mixing together a photochromatic filler and a carrier to form a photochromatic slurry further comprises providing the photochromatic filler as between 1 percent and 5 percent of the slurry by volume.

20. A method of constructing a photochromatic magazine for a firearm, the magazine having a body, a follower, and a follower spring, the method comprising:
mixing together a photochromatic filler, a carrier, and a polymer material to form a mixture; and
forming the mixture into at least a portion of the body.
